(19) United States
(12) Patent Application Publication
(10) Pub. No.: US 2006/0004412 A1
(43) Pub. Date: Jan. 5, 2006

(54) Infant mitten with teething surface

(76) Inventor: Ed Gilbert JR., Dallas, GA (US)

Correspondence Address: Ed Gilbert Jr., 431 Silverleaf Lane, Dallas, GA, 30157, US

(21) Appl. No.: 11/205,308

(22) Filed: Apr. 27, 2005

Related U.S. Application Data
(63) Continuation-in-part of application No. 29/198,180, filed on Jan. 26, 2004, now Pat. No. D509628.

(51) Int. Cl. A61J 17/00

(52) U.S. Cl. 606/234

(57) ABSTRACT

Infants chew on their hands or suck on their fingers during the teething phase of development. These actions are taken place to sooth the infants' gums and stimulate the growth of dentures. A mitten with teething surface (element) will cover the hands and give a more natural way of comfort other than a ring or foreign object. Teething products not attached to the infant hands are susceptible to falling onto different surfaces and collecting contaminations, in turn, the teething product will have to be continuously cleaned. A teething mitten can also deter finger or thumb sucking in the future. The teething mitten may consist of a rubberized surface; either smooth or textured, with a firm or gelatinous consistency.

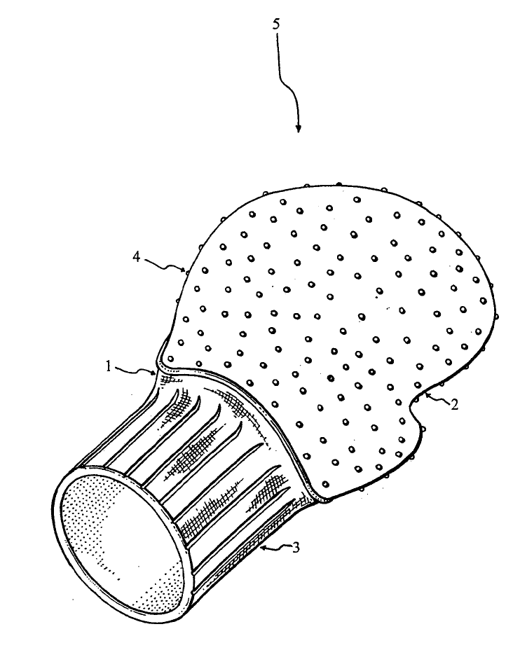

### PARENT CASE TEXT

This is a continuation-in-part to application Ser. No. 29/198,180, filed Jan. 26, 2004

### REFERENCES CITED

### US Patent Documents

U.S. Pat. No. 5,993,285 - - - November 1999 - - - Sofia, et al. - - - 446/327
U.S. Pat. No. 5,385,573 - - - January 1995 - - - Wright - - - 606/235

### DESCRIPTION

### BACKGROUND OF THE INVENTION

1. Field of the Invention

This invention relates generally to infant oral products, more specifically, to infant teething products.

2. Description of the Related Technology

Through natural development, infants chew on various manufactured products to prepare the gums for the cutting of new dentures. This point of development can be difficult for the infant due to the pain and itching of the gums. There are a variety of teething products to help comfort the infant; however, most of these products are small and may be difficult to grasp by the infant, in turn allowing the product to fall onto unsanitary surfaces. Also, the use of foreign object as teethers is not a natural way of development. Accordingly, there is a need for a more sanitary and natural way for infants to cope with the teething process.

### SUMARY OF THE INVENTION

The invention satisfies this need. The invention is a mitten having the teething element attached directly thereto.

The invention is conveniently used by placing the mitten onto the infant's hand. Through natural development, the infant will place his/her hand in the mouth, thus stimulating the gums with the teething surface.

The invention thus provides a simple and inexpensive method to minimize tie frustrations felt by both infant and caregiver due to the frequent dropping of its teething element. The invention also minimizes the chances that the teething element will be dropped by the infant onto an unsanitary surface, such as on the ground or the floor.

These and various other advantages and features of novelty that characterize the invention are pointed out with particularity in the claim annexed hereto and forming a part hereof. However, for a better understanding of the invention, its advantages, and the objects obtained by its use, reference should be made to the drawing which form a further part hereof, and to the accompanying descriptive matter, in which there is illustrated and described a preferred embodiment of the invention.

### BRIEF DESCRIPTING OF THE DRAWING

1. The figure is a perspective view of an infant product having the features of the invention.

2. It is understood that both the front and rear perspective views of the infant product are ornamented as that of the perspective view of the invention.

### DETAILED DESCRIPTION OF THE PREFERRED EMBODIMENT(S)

Referring now to the drawing, wherein like reference numerals designate corresponding structure throughout the view, an infant product 5 that is constructed according to a preferred embodiment of the invention includes a pliable sheath 1 with a teething element 2 attached thereto. The pliable sheath 1 is constructed as to incorporate a wrist retainer 3.

The pliable sheath 1 can be made from any material suitable for the use with an infant, and can be woven or non-woven In typical embodiment, the pliable sheath 1 is a woven material having a woven weight value between 100 pounds and about 140 pounds. When woven, the material can be made of cotton or other suitable organic or non-organic material. In another embodiment, the pliable sheath 1 is made from ethylene vinyl acetate or other suitable non-woven material.

In the typical embodiment, the teething element 2 is a non-smooth surface consisting of multiple nodules 4.

The teething element 2 can be any of the devices commonly known to give pleasure to an infant when inserted into the infant's mouth. The term “teething element” is meant to be interpreted broadly to include all elements made from a non-toxic material, sized and dimensioned to be comfortably inserted or partially retained within an infant's mouth for teething purposes.

The teething element 2 is typically made from a suitable plastic or rubber material, but other materials may be used as well.

In the preferred embodiment, the teething element 2 is attached to the pliable sheath 1 by placing the undersurface of the teething element 2 onto the outer surface of the pliable sheath 1 and then affixing the teething element 2 to the pliable sheath 1, such as by sewing, clamping, gluing or clipping. In the embodiments illustrated in the figure, the teething element 2 is sewn to the pliable sheath 1.

In another embodiment, the teething element 2 can be attached to the pliable sheath 1 distal to the wrist retainer 3, whereas, the pliable sheath 1 terminates distal to the retainer 3 and the teething element 2 covers the remaining hand.

In yet another embodiment of the invention, the teething element 2 can be attached to the pliable sheath 1 by molding the teething element 2 to the pliable sheath 1. This can be accomplished in a variety of ways obvious to those skilled in the art. In all such ways, the teething element 2 is heat-formed onto the pliable sheath 1 or reheated while in contact with the pliable sheath 1 such that the teething element material penetrates into the pliable sheath 1 while hot and then, after being cooled, rigidly adheres to the pliable sheath 1.

The invention provides a simple and inexpensive new infant product having advantages over the prior art. By the use of the invention, health hazards are minimized due to the infant not repeatedly dropping the teething product. Also, the invention will minimize frustrations for the infant and caregiver.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the fill extent indicated by the broad general meaning of the terms in which the appended claims are expressed.

What is claimed is:

1. An infant product comprising a pliable sheath constructed to cover the hand and wrist; the wrist portion of the pliable sheath is constructed as a retainer.
A teething element is permanently secured distal to the wrist-retaining portion, said teething element being fabricated from a material selected from a group consisting of plastic and rubber, said teething element having a non-smooth textured surface thereon and being fabricated from a non-toxic material and being sized and dimensioned to be comfortably inserted and partially retained within an infant's mouth for teething purposes.
